(19) United States
(12) Patent Application Publication
(10) Pub. No.: US 2026/0259319 A1
(43) Pub. Date: Sep. 3, 2026

(54) Radar-Based Perception for Autonomous Vehicles Using End-to-End (E2E) Machine Learning

(71) Applicant: MOTIONAL AD LLC, Boston, MA (US)

(72) Inventors: Bo Yang, Boston, MA (US); Michael Happold, Boston, MA (US); Ishan Khatri, Boston, MA (US)

(21) Appl. No.: 19/163,340

(22) PCT Filed: Mar. 6, 2024
(86) PCT No.: PCT/US24/18716

§ 371 Date: Sep. 8, 2025

Related U.S. Application Data
(60) Provisional application No. 63/489,024, filed on Mar. 8, 2023.
(60) Provisional application No. 63/581,178, filed on Sep. 7, 2023.

(51) Int. Cl. G01S 13/931; G01S 7/35; G01S 13/58; G01S 13/89; G06T 7/11

(52) U.S. Cl. CPC G01S 13/931; G01S 7/356; G01S 13/584; G01S 13/89; G06T 7/11; G06T 2207/10028; G06T 2207/20056; G06T 2207/20081; G06T 2207/20084; G06T 2207/30261

(57) ABSTRACT

Provided are methods for processing radar data, which can include accessing radar analog-to-digital (ADC) data from at least one radar sensor of a vehicle, determining a range-Doppler (RD) data set based on the radar ADC data, determining a range-azimuth-Doppler (RAD) data set based on the RD data set, and determining at least one of (i) object data representing at least one object in an environment of the vehicle or (ii) a segmentation map representing the environment based on the RAD data set.

### CROSS REFERENCE TO RELATED APPLICATION

This application claims priority to U.S. Provisional Application No. 63/489,024, entitled “Radar-Based Perception for Autonomous Vehicles Using End-to-End (E2E) Machine Learning” filed on Mar. 8, 2023, and to U.S. Provisional Application No. 63/581,178, entitled “Radar-Based Perception for Autonomous Vehicles Using End-to-End (E2E) Machine Learning” filed on Sep. 7, 2023, the disclosures of which are incorporated herein by reference in their entirety.

### BACKGROUND

In general, autonomous vehicles obtain sensor data to determine characteristics of the environment and control vehicle operations. As an example, an autonomous vehicle obtains sensor data to determine the location of an obstacle in the environment, and navigate around the obstacle.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5 is a diagram of an example end-to-end (E2E) machine learning system;

FIG. 6 is a diagram of example ADC (left) and RD (right) arrays.

FIG. 7 is a diagram of two data samples from the RADIal.

FIG. 8 is a diagram of example signal processing steps for generating a RD data set from ADC data.

FIG. 9 is a diagram showing an example E2E machine learning system in greater detail.

FIG. 10 is a diagram of an example learnable DFT layer.

FIG. 11 is a diagram of example prediction samples generated by the implementations described herein.

FIG. 12 is a diagram of example RAD prediction examples generated by the implementations described herein.

FIG. 13 is a diagram of an example Hanning window.

FIG. 14 is a diagram showing a comparison the real part of Doppler DFT weights (dim=256), before and after training.

FIG. 15 is a diagram showing an example Hanning window for the range dimension, before and after training.

FIG. 16 is a diagram showing an example Hanning window for the Doppler dimension, before and after training.

FIG. 17 is a flow chart diagram of an example process for processing radar data.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement radar-based perception for autonomous vehicles using end-to-end (E2E) machine learning.

In an example implementation, a computer system receives raw radar analog-to-digital (ADC) data from one or more radar sensors of a vehicle. Further, the computer system uses a machine learning circuit to determine a range-Doppler (RD) data set corresponding to the raw radar ADC data, and a range-azimuth-Doppler (RAD) data set corresponding to the RD data set. Further still, using on the machine learning circuit, the computer system determines (i) information regarding one or more objects in the environment of the vehicle (e.g., distance for the object from the vehicle, heading of the object relative to the vehicle, and/or velocity of the vehicle), and (ii) a segmentation map of the environment (e.g., indicating drivable areas and non-drivable areas). This determined information can be used to autonomously operate the vehicle in the environment (e.g., to safely navigate the environment avoiding collisions with any objects in the environment).

In some implementations, the machine learning circuit is “pre-trained” using training data that includes (i) example raw radar ADC data, and (ii) RAD data sets corresponding to that raw radar ADC data. Based on this training data, at least a portion of the machine learning circuit can be trained to predict a RAD data set, given particular input radar data (e.g., raw radar ADC data).

Further, in some implementations, the entirety of the machine learning circuit can be trained using a training data that includes (i) example raw radar ADC data, (ii) object data corresponding to that raw ADC data, and (iii) segmentation maps corresponding to that raw radar ADC data. Based on this training data, the machine learning circuit can be trained to predict the characteristics of objects in an environment of a vehicle and segmentation maps of the environment, given particular input radar data (e.g., raw radar ADC data).

The embodiments described herein can provide various technical benefits.

As an example, the systems and techniques described herein enable an autonomous vehicle navigate its environment in a safe manner (e.g., by minimizing or otherwise reducing the likelihood that the autonomous vehicle collides with objects in the environment).

Further, these systems and techniques enable an autonomous vehicle to use radar sensors to detect objects in its environment more reliably, accurately, and/or precisely than would otherwise be possible absent these systems and/or techniques.

Further, these systems and techniques reduce an autonomous vehicle's reliance on light detection and ranging (LiDAR) sensors, which in some circumstances may be more expensive than radar sensors and/or may be less suitable for use in certain conditions (e.g., rain, fog, or other inclement weather) than radar sensors.

Nevertheless, in some implementations, the systems and techniques can be used in conjunction with LiDAR sensors. For example, an autonomous vehicle can use radar sensors and LiDAR sensors to obtain multi-modality sensor data, in order to further enhance its perception in varying conditions and environments.

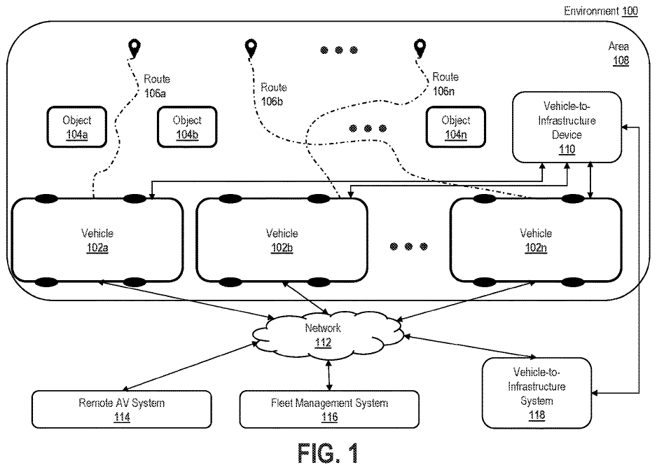

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a -102n, vehicle-to-infrastructure (V2I) device 110, network 112, autonomous vehicle (AV) system 114, fleet management system 116, and V2I system 118 via wired connections, wireless connections, or a combination of wired or wireless connections.

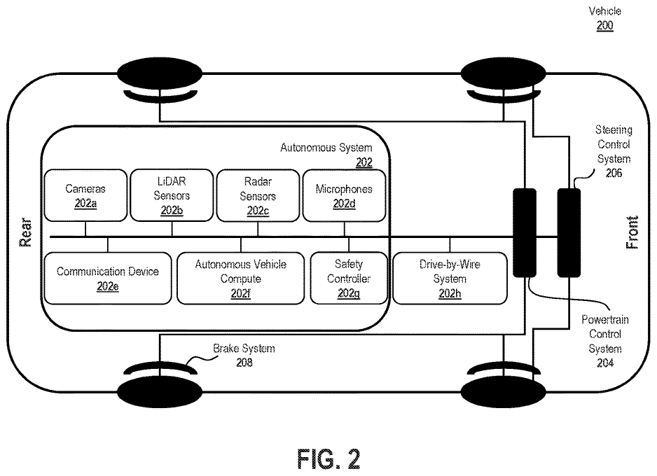

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

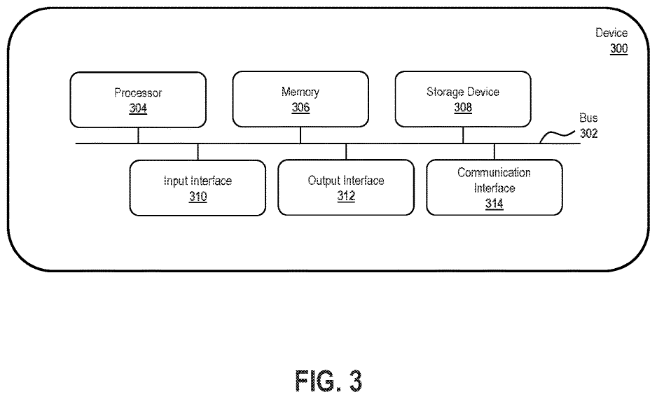

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), one or more devices of network 112 (e.g., one or more devices of a system of network 112), and/or any other device of the environment 100. In some embodiments, one or more devices of vehicles 102 (e.g., one or more devices of a system of vehicles 102), one or more devices of network 112 (e.g., one or more devices of a system of network 112), and/or any other device of the environment 100 include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

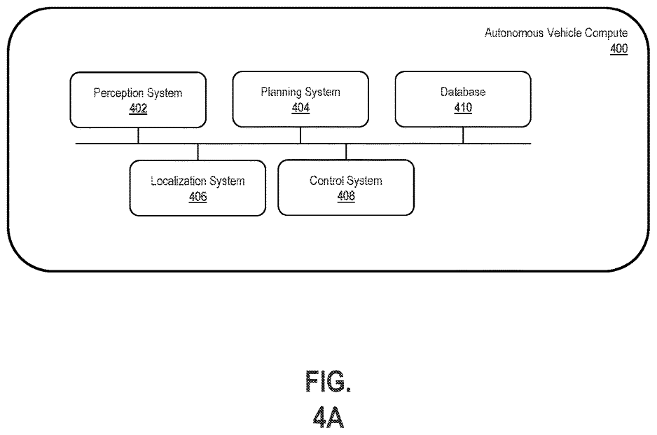

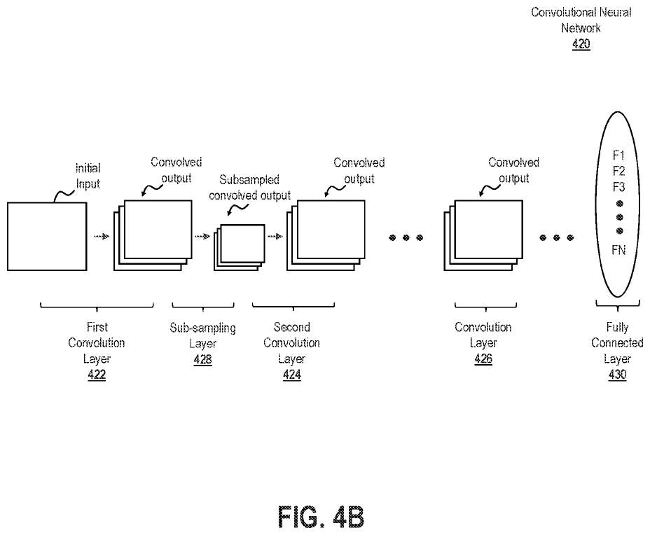

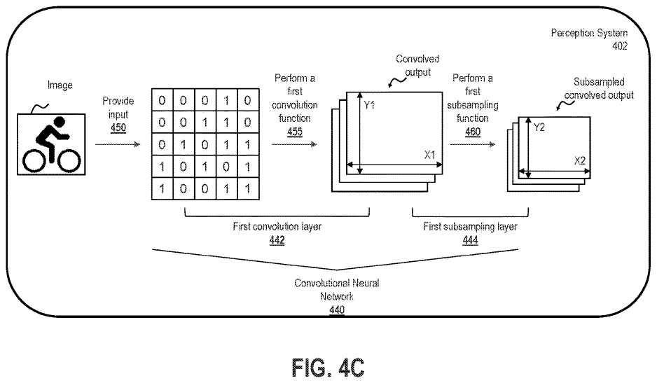

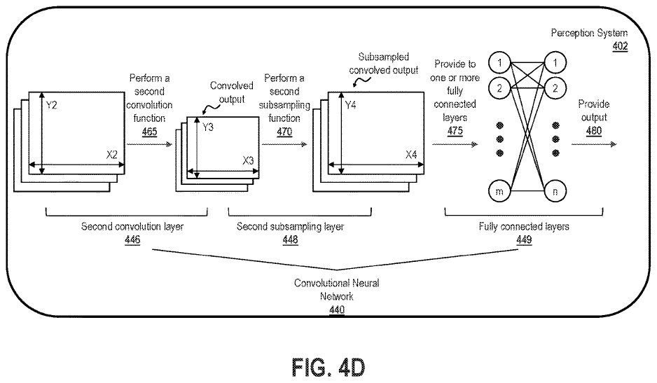

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Example End-to-End (E2E) Machine Learning System for Radar-Based Perception:

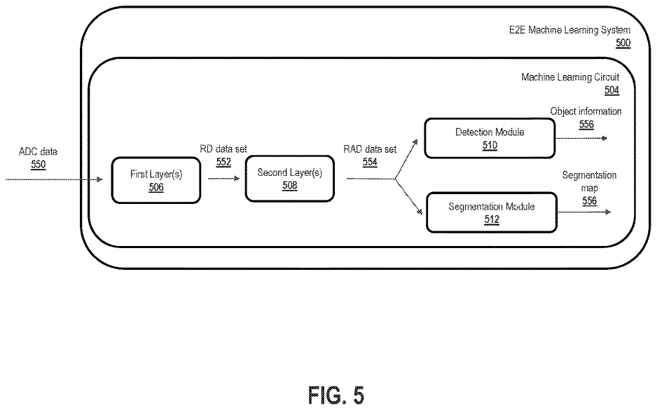

An example implementation of an end-to-end (E2E) machine learning system 500 for radar-based perception is shown in FIG. 5. Example embodiments of the E2E machine learning system 500 can be deployed in an AV (e.g., the vehicles 102a-102n, 200, etc.).

In general, the E2E machine learning system 500 includes a machine learning circuit 504 that is configured to receive raw radar analog-to-digital (ADC) data from one or more radar sensors of a vehicle (e.g., the radar sensors 202c), and output corresponding range-azimuth-Doppler (RAD) data based on the ADC data.

In particular, the E2E machine learning system includes one or more first machine learning layers 506 configured to receive ADC data 550 as input (e.g., from the radar sensors 202c), and output a range-Doppler (RD) data set 552 based on the inputted ADC data 550.

Further, the E2E machine learning system includes one or more second layers 508 configured to receive the RD data set 552 as input (e.g., from the one or more first machine learning layers 506), and output a RAD data set 554 based on the inputted RD data set 552.

The RD data set 552 and the RAD data set 554 are predictions or approximations of the RD data and the RAD data, respectively, that would be obtained by processing the ADC data according to standard radar processing techniques (e.g., by performing range estimation, Doppler estimation, peak estimation, threshold, and/or angle-of-arrival (AoA) estimation). However, the machine learning circuit 504 is trained to output the RD data set 552 and the RAD data set 554 (e.g., using one or more neural networks), without performing these radar processing techniques. Accordingly, the E2E machine learning system 500 can generate processed radar data (e.g., RD data and/or RAD data) more quickly and/or using a fewer computational resources (e.g., compared to using standard radar processing techniques).

Further, the RAD data set 554 is provided to a detection module 510 and a segmentation module 512. The detection module 510 is configured to determine information 556 regarding one or more objects in the environment of the vehicle (e.g., distance for the object from the vehicle, heading of the object relative to the vehicle, and/or velocity of the vehicle) based on the RAD data set 554. Further, the segmentation module 512 is configured to determine a segmentation map 558 of the environment (e.g., indicating drivable areas and non-drivable areas) based on the RAD data set 554. This determined information can be used to autonomously operate the vehicle in the environment (e.g., to safely navigate the environment avoiding collisions with any objects in the environment). For example, the determined information can be provided to the perception system 402, the planning system 404, and/or the localization system 406 to facilitate autonomous driving operations of the vehicle 200.

In some implementations, the machine learning circuit 504 (including one or more of its constituent layers or modules) is implemented using one or more neural networks. As an example, some or all of the machine learning circuit 504 can be implemented using one or more convolutional neural networks 420 (e.g., as described with reference to FIGS. 4B-4D).

In some implementations, the machine learning circuit 504 is “pre-trained” using training data that includes (i) example raw radar ADC data, and (ii) RAD data sets corresponding to that raw radar ADC data (e.g., RAD data sets that were obtained by processing the ADC data according to standard radar processing techniques). Based on this training data, at least a portion of the machine learning circuit can be trained to predict a RAD data set, given particular input radar data (e.g., raw radar ADC data).

Further, in some implementations, the machine learning circuit 504 can be trained using a training data that includes (i) example raw radar ADC data, (ii) object data corresponding to that raw ADC data, and (iii) segmentation maps corresponding to that raw radar ADC data. Based on this training data, the machine learning circuit can be trained to predict the characteristics of objects in an environment of a vehicle and segmentation maps of the environment, given particular input radar data (e.g., raw radar ADC data).

The embodiments described herein can provide various technical benefits.

As an example, the E2E machine learning system 500 enables an autonomous vehicle navigate its environment in a safe manner (e.g., by minimizing or otherwise reducing the likelihood that the autonomous vehicle collides with objects in the environment).

Further, the E2E machine learning system 500 enables an autonomous vehicle to use radar sensors to detect objects in its environment more reliably, accurately, and/or precisely than would otherwise be possible absent these systems and/or techniques.

Further, the E2E machine learning system 500 reduce an autonomous vehicle's reliance on light detection and ranging (LiDAR) sensors, which in some circumstances may be more expensive than radar sensors and/or may be less suitable for use in certain conditions (e.g., rain, fog, or other inclement weather) than radar sensors.

Nevertheless, in some implementations, the E2E machine learning system 500 can be used in conjunction with LiDAR sensors. For example, an autonomous vehicle can use radar sensors and LiDAR sensors to obtain multi-modality sensor data, in order to further enhance its perception in varying conditions and environments.

In some implementations, the E2E machine learning system 500 is configured to process data obtained using Frequency Modulated Continuous Wave (FMCW) radar systems (e.g., FMCW radar systems used for automotive perception). In general, at each measuring cycle, a FMCW radar system sends out a series of rapid “chirps” (e.g., short waves with increasing frequency). At the receiving antenna, the reflections are captured, and sampled by an ADC device.

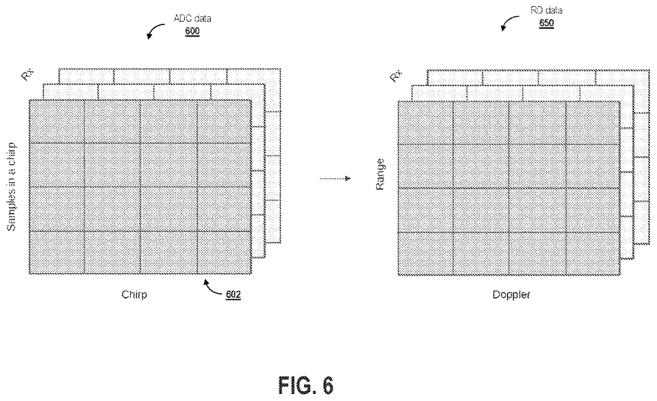

FIG. 6 shows an example representation of ADC data 600. The ADC data 600 is organized as arrays. The frontal slab 602 of the array has two dimensions (e.g., representing number of samples per chirp, and the number of chirps, respectively), and holds all the samples for one receiving antenna. Signal processing operations (e.g., digital Fourier transforms (DFTs)) can be performed to transform these two dimensions into range and Doppler dimensions, forming the RD array 650.

### The RADIal Dataset:

In general, aspects of the E2E machine learning system 500 can be implemented, trained, and/or validated using the RADIal dataset.

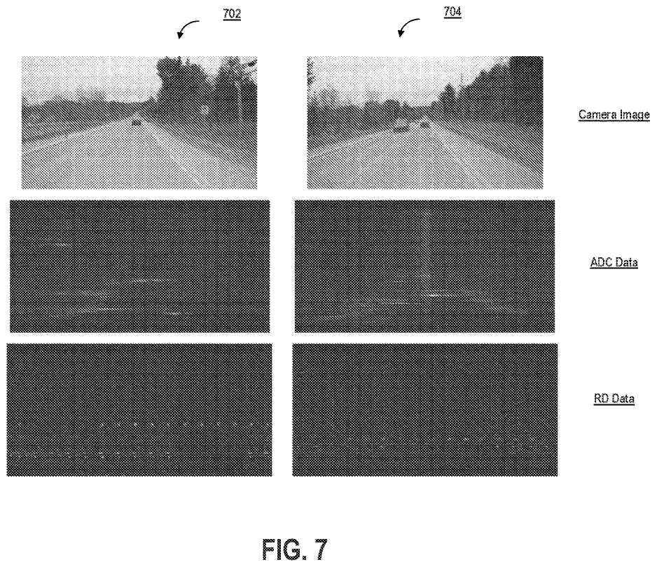

In general, the RADIal dataset provides synchronized radar, LiDAR, and camera images for about two hours of driving. Labels for vehicle detection and freespace segmentation are also provided. Specifically, the radar data includes ADC data and RD data. The RADIal SDK also enables generating RAD maps from the ADC data. FIG. 7 shows two samples 702 and 704 from the dataset.

The radar sensor used in the RADIal dataset is an imaging radar with 12 transmit antenna and 16 receiving antennas. Doppler division multiplexing is employed in the radar waveform design. This can be seen from FIG. 7, where a single target produces multiple equal-spaced bright spots in the RD map. The radar is mounted at the front of the vehicle, and has an approximate field-of-view (FOV) of 180 degrees, and a range of around 100 meters.

The RADIal dataset contains a relatively balanced distribution of driving scenes in city, country side, and highway. For the object detection task and the freespace segmentation task, the labels are generated by models running on images and LiDAR, followed by human verification. Only vehicles are labeled for object detection.

Note that, out of the total 25,000 synced data frames, only about 8300 frames have objects and segmentation label. Section 1.3 describes an example technique to utilize the unlabeled dataset for pre-training and learn a meaningful representation. 1. The ADCNet:

In general, aspects of the E2E machine learning system 500 can be implemented using the system and techniques described herein (also referred to as “ADCNet”).

### 1.1. A Trainable Digital Signal Processing (DSP) Module

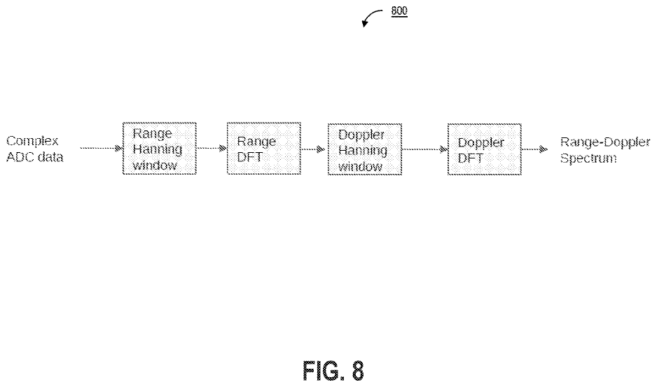

The FFTRadNet model (e.g., as described in Julien Rebut, Arthur Ouaknine, Waqas Malik, and Patrick Perez. Raw high-definition radar for multi-task learning. In Proceedings of the IEEE/CVF Conference on Computer Vision and Pattern Recognition, pages 17021-17030, 2022) learns to perform object detection and freespace segmentation, using radar RD data. For the RADIal dataset, the RD data is generated from ADC data by applying DFT and windowing functions, as commonly performed in radar signal processing. The specific signal processing steps for the RADIal dataset are summarized in FIG. 8. In particular, in a process 800, a system receives complex ADC data, applies a range Hanning window function to the ADC data, performs a range DFT with respect to the ADC data, applies a Doppler Hanning window function to the ADC data, and performs a Doppler DFT with respect to the ADC data to obtain a Range-Doppler spectrum.

The E2E learning techniques described herein (e.g., learning to predict RAD data from ADC data) starts from signal processing. For example, the E2E machine learning system 500 includes layers that mimics signal processing steps in the early part of the neural network, while these signal processing-like layers are trained E2E together with other layers. Section 2.5 describes experiments that examine this hypothesis.

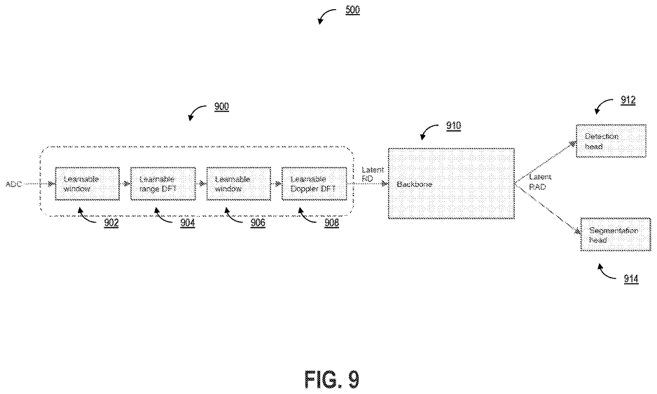

For instance, as shown in FIG. 9, the E2E machine learning system 500 includes a digital signal processing (DSP) module 900 for generating a predicted RD data set (also referred to as a “latent” RC data set) based on the raw ADC data. As an example, the DSP module 900 includes a learnable window layer 902, a learnable range DFT 904, a learnable window layer 906, and a learning Doppler DFT layer 908. In some implementations, the DSP module 900 can correspond to the one or more first layers 506 described with reference to FIG. 5.

As shown in FIG. 9, the E2E machine learning system 500 also includes one or more layers forming a backbone network 910 for generated a predicted RAD data set (also referred to as a “latent” RAD data set based on the predicted RD data generated by the DSP module 900. In some implementations, the backbone network 910 can correspond to the one or more second layers 508 described with reference to FIG. 5.

The E2E machine learning system 500 also includes (i) a detection head 912 for generating object information based on the predicted RAD data set and (ii) a segmentation head 914 for generating segmentation maps based on the predicted RAD data set (e.g., corresponding to the detection module 510 and the segmentation module 512, respectively, as described with reference to FIG. 5).

In some implementations, some or all of the DSP module 900 (including one or more of the layers 902, 904, and 906), the backbone network 910, the detection head 912, and/or the segmentation head 914 can be implemented using one or more convolutional neural networks 420 (e.g., as described with reference to FIGS. 4B-4D). Further, each of these the DSP module 900 (including one or more of the layers 902, 904, and 906), the backbone network 910, the detection head 912, and/or the segmentation head 914 can be trained to produce particular output, given a particular input. For example, at least some of these components can be trained based on training data (e.g., RADIal data set or other data sets including collections of corresponding ADC, RD, and/or RAD data) to mimic the signal processing steps that would be performed in processing raw ADC data according to traditional radar signal processing techniques.

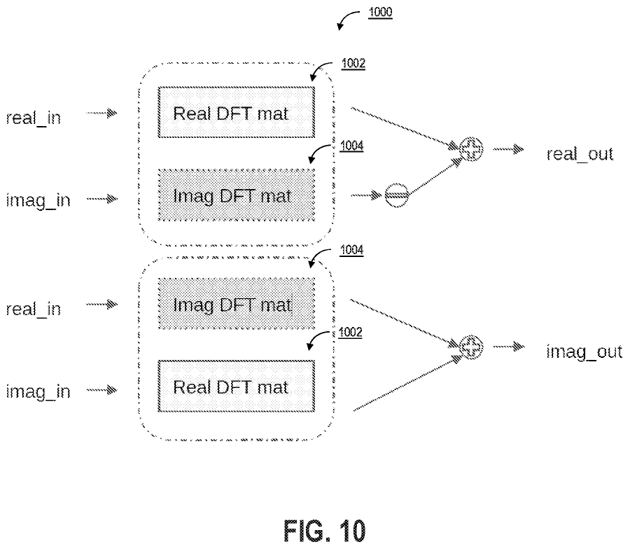

As an example, FIG. 10 shows an example learnable DFT layer 1000. The two modules 1002 and 1004 inside the dashed boxes represent parameter matrices of a neural network, and are initialized as (perturbed) real and imaginary parts of the DFT matrix.

For instance, the learnable DFT layer 1000 receives an input having a real component and an imaginary component (represented as “real_in” and “imag_in,” respectively). Based on the input, the learnable DFT layer 1000 determines a corresponding output having a real component and an imaginary component (represented as “real_out” and “imag_out,” respectively).

In particular, the real component of the output (“real_out”) is determined by adding (i) the product of the real component of the input (“real_in”) multiplied by a real DFT matrix 1002, and (ii) the inverse of the product of the imaginary component of the input (“imag_in”) multiplied by an imaginary DFT matrix 1004). The real DFT matrix 1002 and the imaginary DFT matrix 1004 are learn parameter matrices of a neural network.

Further, the imaginary component of the output (“imag_out”) is determined by adding (i) the product of the real component of the input (“real_in”) multiplied by the imaginary DFT matrix 1004, and (ii) the product of the imaginary component of the input (“imag_in”) multiplied by the real DFT matrix 1002). As described above, the real DFT matrix 1002 and the imaginary DFT matrix 1004 are learn parameter matrices of a neural network.

At initialization, the DSP module 900 mimics signal processing operations. If the DSP module 900 were initialized to be the exact signal processing chain used in FFTRadNet, then the ADCNet would be the same as FFTRadNet at initialization, while the SP module 900 is left trainable during the training process.

However, initializing the DSP module 900 exactly as the signal processing chain of FFTRadNet can hurt performance, since the training process may fail to drive the weights away from signal processing (e.g., as signal processing is indeed a “good” solution, in at least some implementations). To combat this potential issue, a perturbed-DFT initialization strategy can be employed, specifically using the following equation:

$$M = {M}_{DFT} + 𝒩 ( 0 , γ ) \qquad Eq . ( 1 )$$

In Eq. 1, M_{DFT} denotes the DFT matrix, and N(0,γ) denotes a random Gaussian matrix (with the same shape as the DFT matrix), with i.i.d. elements each has mean 0, and variance γ. Intuitively, this γ parameter should be small, such that the final matrix M used for initializing the DSP module 900 is perturbed, but still resemble the DFT matrix. In our experiments, the γ is set to 0.1. The effect of this perturbation is examined in Section 1.5.

### 1.2. Supervised Model Training

To facilitate comparison with FFTRadNet, we performed experiments using the same multi-task learning setup. Specifically, the E2E machine learning system 500 (e.g., “ADCNet”) was trained to perform both object detection and freespace segmentation at the same time.

For model training, the object detection part of the loss is

$${ℒ}_{det} = focal ( {y}_{cls} , {\hat{y}}_{cls} ) + α smooth - L 1 ( {y}_{reg} , {\hat{y}}_{reg} ) , \qquad Eq . ( 2 )$$

where y_{cls} denotes the ground-truth classification labels on the feature map, with 1 indicates presence of object while 0 otherwise. The shape of y_{cls} is N_{range-bins}×N_{azimuth-bins}. The y_{reg} denotes the regression targets. The network predicts a range and an azimuth value. The regression targets are thus the remainders of range and azimuth modulo range and azimuth bin sizes. The shape of y_{reg} is N_{range-bins}×N_{azimuth-bins}×2, where the last dimension corresponds to range and azimuth. The focal( ) function is described in Tsung-Yi Lin, Priya Goyal, Ross Girshick, Kaiming He, and Piotr Doll'ar. Focal loss for dense object detection. In Proceedings of the IEEE International Conference on Computer Vision, pages 2980-2988, 2017., and the smooth-L1( ) function is also known as Huber loss.
The α is a hyper-parameter balancing the two parts.

The freespace segmentation part of the loss is

$${ℒ}_{seg} = {\sum }_{r , a} BCE ( {y}_{seg} ( r , a ) , {\hat{y}}_{set} ( r , a ) ) \qquad Eq . ( 3 )$$

where y_{seg}(r, a) denotes the ground truth at location (r, a), with 1 denotes object presence and 0 otherwise. The BCE( ) term denotes the binary cross entropy loss.

Combining the two parts, the loss function for training is thus

$$ℒ = {ℒ}_{det} + {βℒ}_{set} \qquad Eq . ( 4 )$$

where β is a hyper-parameter controlling the weights on the freespace segmentation task.

### 1.3. A Signal Processing-Guided Pre-Training Scheme

In general, only a small part of all the frames from RADIal are labeled. This is likely to hold true for other (future) radar datasets as well, since collection of data samples is relatively easy while obtaining high-quality labels is difficult and costly. This is especially true with raw radar data since radar data tends to be less human interpretable and requires sensor fusion techniques for accurate 3D labels. We envision that leveraging a large collection of unlabeled data will help with E2E learning. This is because learning from ADC data directly means disregarding important prior information (e.g.m the fact that fast-time frequency correspond to target range, and slow-time frequency correspond to relative radial velocity), in order to leave larger parameter space for data-driven learning.

While exposing the model to a larger dataset is a good motivation, the proposed pre-training method is further designed to exploit advanced techniques in signal processing. In particular, in at least some implementations, the machine learning circuit (e.g., the machine learning circuit 504) is pre-trained such that it learns to estimate angle-of-arrival (AoA) of targets. In particular, the machine learning circuit can be pre-trained to obtain estimated range and Doppler information, such that the Range-Azimuth-Doppler cube can be determined from the radar ADC data. For example, spatial information, such as range and azimuth help localize the object in the scene, while Doppler information is used to distinguish between moving and static objects. Such a data representation can be particular useful for downstream perception tasks.

Learning from the time-tested signal processing algorithms is well motivated. A considerable amount of effort has been devoted to study the angle estimation problem (core step in generating the RAD map) in the signal processing community. These algorithms are designed to achieve some very beneficial properties, such as noise robustness, outlier rejection, and interference mitigation capability. Intuitively, many of these algorithms can be good fit to generate RAD, and can serve as the training signal to guide the training of the neural network.

For example, in some implementations, the proposed pre-training method can include two main steps:
1. Using a signal processing algorithm, generating RAD from all the ADC data;
2. Using the collected (ADC, RAD) pairs as input and (pseudo) labels to train the trunk network in a supervised learning fashion.

Unlike unsupervised pre-training techniques, which usually ask the neural network to predict missing parts of the signal (e.g., predictive coding in the audio domain), or to differentiate “real” and “fake” samples as in the contrastive learning regime, the implementations described herein are designed to learn from an algorithm. For example, a machine learning circuit (e.g., a neural network) can be tasked to learn the mapping between ADC and RAD, where the RAD is generated by a classical signal processing algorithm.

To test the E2E machine learning system 500, RAD map for all the available ADC data was generated using the RADIal SDK (e.g., to obtain a collection of (ADC, RAD) pairs). These pairs were used to pre-train the DSP module 900 and backbone network 910, with the following loss

$$ℒ = smooth - L 1 ( {Y}_{RAD} - {\hat{Y}}_{RAD} ) \qquad Eq . ( 5 )$$

where Y_{RAD} denotes the generated RAD tensor and Ŷ_{RAD} denotes the prediction of the neural network. From the RADIal SDK, the generated RAD tensor is of shape 512×751×256. The tensor was downsampled to have shape 128×248×256 for easier training. After pre-training the trunk of the system, the machine learnign circuit (e.g., the neural network) was fine0tuned with the multi-task setting, as describe in Section 1.2.

### 3. Experiment Results

This section presents experiment results that verified the effectiveness of the proposed techniques. An overall comparison is presented in in Section 3.3, while design and present ablation studies are described in the following subsections.

### 3.1. Baseline Methods

For at least some of the implementations described herein, FFTRadNet is a particularly relevant baseline for comparison.

The Pixor method (e.g., as described in Bin Yang, Wenjie Luo, and Raquel Urtasun. Pixor: Realtime 3d object detection from point clouds. In Proceedings of the IEEE conference on Computer Vision and Pattern Recognition, pages 7652-7660, 2018) was also included for comparison. For this method, two different radar data representations were used: pointclound and RA map. For the pointcloudbased method, the pointcloud was voxelized into a 3D volume before feeding into the network; for the RA-based method, the RA input was formed by collapsing (summing over) the Doppler dimension of the RAD tensor. In order to ensure a fair comparison, the hyper-parameters were first optimized for FFTRadNet. Improved performance was observed for FFTRadNet with a different batch-size and learning-rate than the original paper (see Table 1). These optimized FFTRadNet were used as the baseline in the comparison.

### 2.2. Experiment Setup

Data partitioning: The whole labelled dataset was split into train, val, and test set by sequence (driving session). That is, data samples from a sequence could only appear in one of the split. This was to avoid allocating closely-resembling data samples (e.g. two consecutive data samples in the same driving session) to the same split, which could have led to inflated performance metrics.

Evaluation: Object detection performance was measured by average-precision and average-recall, where average was performed across a range of detection thresholds. The freespace segmentation results were evaluated with mIOU metric: the average IOU (intersection over union) score across test samples

For the pre-training experiments in Section 2.4, it is important to note that any samples from the labeled test set sequences were not included in the pre-training stage. This avoided giving unfair advantages to the E2E machien learning system described herein, so that it is not allowed to see test samples even in the pre-training stage.

### 2.3. Comparing ADCNet to Baselines

This section includes as comparison of the E2E machine learning system described herein (“ADCNet”0 to multiple baselines. Two variant of ADCNet—with and without pre-training were considered. To differentiate these, the system that was pre-trained was denoted as ADCNet-PTFT, where PTFT stands for “pretraining & fine-tuning”.

TABLE 1
Comparing ADCNet with baselines.

| | | All | | | | Easy | | | | Hard | | | |
|---|---|---|---|---|---|---|---|---|---|---|---|---|---|
| | Radar Input | AP | AR | RE (m) | AE (°) | AP | AR | RE (m) | AE (°) | AP | AR | RE (m) | AE (°) |
| FFTRadNet-paper * | RD | 0.97 | 0.82 | 0.11 | 0.17 | 0.98 | 0.92 | 0.10 | 0.13 | 0.93 | 0.65 | 0.13 | 0.26 |
| Pixor-PO * | Pointcloud | 0.96 | 0.82 | 0.17 | 0.25 | 0.99 | 0.29 | 0.15 | 0.19 | 0.93 | 0.39 | 0.19 | 0.33 |
| Pixor-RA * | RA | 0.97 | 0.82 | 0.10 | 0.20 | 0.97 | 0.88 | 0.09 | 0.16 | 0.96 | 0.70 | 0.12 | 0.27 |
| FFTRadNet-optimized | RD | 0.92 | 0.89 | 0.15 | 0.11 | 0.95 | 0.97 | 0.14 | 0.10 | 0.87 | 0.74 | 0.17 | 0.13 |
| ADCNET | ADC | 0.96 | 0.87 | 9.12 | 0.10 | 0.98 | 0.97 | 0.11 | 0.10 | 0.91 | 0.68 | 0.16 | 0.12 |
| ADCNET-PTFT | ADC | 0.95 | 0.89 | 0.13 | 0.11 | 0.96 | 0.98 | 0.12 | 0.11 | 0.91 | 0.73 | 0.16 | 0.12 |

AP: Average Precision, AR: Average Recall, RE: Range Error on detected objects, AE: Azimuth Error on detected objects.
The full testset is broken down into an Easy and a Hard subset for detailed comparison.

TABLE 2
Freespace segmentation comparison.

| | All | Easy | Hard |
|---|---|---|---|
| FFTRadNet * | 74.00% | 74.60% | 72.30% |
| PolarNet \|19\| * | 60.6% | 61.9% | 57.4% |
| FFTRadNet-optimized | 76.74% | 77.83% | 73.96% |
| ADCNet | 74.45% | 75.85% | 70.89% |
| ADCNet-PTFT | 78.59% | 79.63% | 75.90% |

The performance is measured by mIOU, the higher the value the better.

The object detection performance results are shown in Table 1, and the freespace segmentation results are presented in Table 2. Overall, the ADCNet-PTFT system out-performed FFTRadNet for both tasks. In particular, the ADCNet-PTFT system achieved about 2% higher freespace segmentation mIOU, while at the same time outperforming the well tuned FFTRadNet-optimized system on the detection task. The benefit of pre-training is apparent when comparing ADCNet and ADCNet-PTFT. For example, compared with ADCNet, ADCNet-PTFT achieved about 4 points improvement on the freespace segmentation task on the full test set.

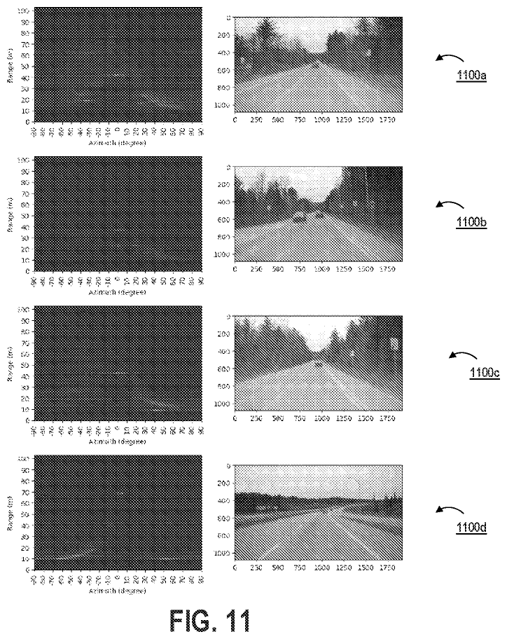

Several model prediction samples 1100a-1100d are presented in FIG. 11. The small red squares in the RA image denote ground truth, while the blue squares denote network predictions. It can be seen from the samples that the E2E machine learning system was able to correctly recognize the cars while rejecting other bright spots in the RA images. In the second sample 1100b, the E2E machine learning system missed one car, possibly due to the road sign on the right, which caused a bright spot in the RA map, at a similar range of the missed car.

### 2.4. RAD Prediction Accuracy in Pre-Training

In Table 1 and Table 2, the effect of pre-training is evident by comparing ADCNet and ADCNet-PTFT. In this section, the prediction accuracy of RAD tensor in the pre-training stage is examined. This is a valid question, as both the ADC tensor and the RAD were large: ADC was of shape 512×256×8 while RAD was 128×248×256 for the RADIal dataset. A priori, it was unclear whether learning a mapping between these two high-dimensional vectors would be feasible.

While the results from Table 1 and Table 2 hint that pre-training is successful, the lowest validation loss (calculated on 2014 samples) that was observed during training is about 1.6. This is a very small error, as the ground truth (power spectrum) values of RAD is distributed around 60.

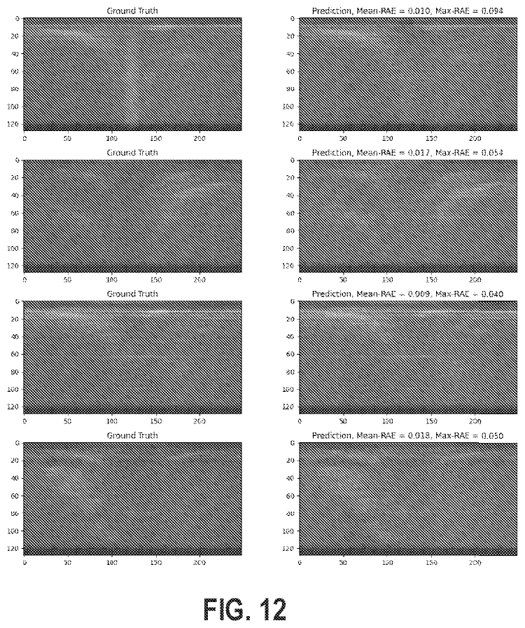

Furthermore, several RAD prediction samples were visualized (e.g., as shown in FIG. 12). To visualize this 3D RAD tensor, a sum was generated over the third dimension, and a 2D image of dimension range and azimuth was obtained. To obtain a quantitative error measure, the Relative Absolute Error (RAE) for each RAD entry was computed as

$$RAE ( i , j , k ) = \frac{\vert {Y}_{RAD} ( i , j , k ) - {\hat{Y}}_{RAD} ( i , j , k ) \vert}{\vert {Y}_{RAD} ( i , j , k ) \vert} \qquad Eq . ( 6 )$$

As such, a relative error measure was obtained for each entry. The maximum and mean of these errors is presented in FIG. 12.

It can be seen from FIG. 12 that the E2E machine learning system could predict RAD tensor to a very high accuracy: the ground truth and predicted images were visually close, and the RAE measurements confirmed this observation.

### 2.5. Different Methods for SP Module Initialization

Further, an ablation study regarding the initialization method for the learnable DSP module was performed. In particular, the following methods and/or system were compared to one another
Perturb-DFT initialization: perturbed DFT matrices as shown in Equation 1 were used to initialize both the range and Doppler DFT module in FIG. 8
Exact-DFT initialization: the exact DFT matrices were used to initialize both the range and Doppler DFT module
Random-Doppler initialization: the exact DFT matrix was used to initialize the range DFT, while a randomly generated matrix was used for Doppler Random: randomly generated matrices are used for both range and Doppler modules

These methods employed a various amount of signal programming knowledge: the Exact-DFT method relied fully on signal processing, and the Random method almost completely disregarded signal processing, while Perturbed-DFT and Random-Doppler lied in between.

TABLE 3
Comparing different initialization methods for ADCNet.

| | AP (%) | AE (%) | RE (m) | AE (°) | mIOU |
|---|---|---|---|---|---|
| Exact-DFT | 90.61 | 84.04 | 0.12 | 0.10 | 75.6% |
| Random-Doppler | 91.45 | 73.69 | 0.16 | 0.10 | 74.43% |
| Perturbed-DFT | 95.73 | 86.77 | 0.12 | 0.10 | 74.5% |

| | |
|---|---|
| Random | Failed to converge |

The numbers represent the performance on the full test set.

The results are shown in Table 3. As can be seen, the Perturbed-DFT yielded the best results. Using the Exact-DFT initialization method led to sub-optimal performance. This may be because the network became stuck in a local minima when initialized exactly. This explanation also explains why the perturbed DFT method performed better, as it encouraged learning beyond the exact DFT parameters. The Random-Doppler methods yielded considerably worse performance, while the Random method failed to converge to any meaningful model.

Since the Exact-DFT and Perburbed-DFT initialization methods exhibited better performance than other choices, a more in-depth comparison is provided between the two. Moreover, these initialization methods were also implemented in the pre-training stage, and the fine-turning step was carried out to obtain the final performance. For this experiment, the multitask learning setup as described in Section 1.2 was performed, with and without pre-training. All the hyper-parameters were kept the same, and only the initialization method were varied.

TABLE 3
Comparing Exact-DFT and Perturbed-DFT initialization method for the object detection task.

| | | AH | | | | Easy | | | | Hard | | | |
|---|---|---|---|---|---|---|---|---|---|---|---|---|---|
| | Initialization | AP | AR | RE (m) | AE (°) | AP | AR | RE (m) | AE (°) | AP | AR | RE (m) | AE (°) |
| ADCNet | Exact-DFT | 96.00% | 84.00% | 0.13 | 0.1 | 98.00% | 93.00% | 0.12 | 0.09 | 91.00% | 67.00% | 0.15 | 0.12 |
| ADCNet | Pertubed-DFT | 95.73% | 86.77% | 0.12 | 0.1 | 97.65% | 97.09% | 0.11 | 0.1 | 91.05% | 67.94% | 0.16 | 0.12 |
| ADCNet-PTFT | Exact-DFT | 98.00% | 86.00% | 0.13 | 0.1 | 95.00% | 97.00% | 0.12 | 0.1 | [symbol] | 62.00% | 0.15 | 0.12 |
| ADCNet-PTFT | Pertubed-DFT | 94.54% | 89.12% | 0.13 | 0.11 | 96.25% | 98.14% | 0.12 | 0.11 | [symbol] | 72.65% | 0.16 | 0.12 |

[symbol]

indicates data missing or illegible when filed

TABLE 5
Comparing Exact-DFT and Perturbed-DFT initialization method for
the freespace segmentation task.

| | Initialization | All | Easy | Hard |
|---|---|---|---|---|
| ADCNet | Exact-DFT | 70.39% | 70.81% | 69.31% |
| ADCNet | Perburbed-DFT | 74.45% | 75.85% | 70.89% |
| ADCNet-PTFT | Exact-DFT | 77.28% | 78.37% | 74.50% |
| ADCNet-PTFT | Perturbed-DFT | 78.59% | 79.63% | 75.90% |

The results are reported in Table 4 and Table 5. As can be seen from these tables, with and without pre-training, the Perturbed-DFT initialization method always yielded better performance than Exact-DFT. The improvement by using Perturbed-DFT is especially visible for ADCNet, confirming our intuition that a larger dataset is needed for end2enE2Ed learning, as limited training data may not be able to nudge the network too far from the SP-based initialization.

As discussed in Section 1.1, the γ parameter in Eq. 1 should be chosen with care: a large γ can destroy the DFT structure, while a too small γ can leave the SP module in a non-optimal local minimal. An experiment was performed where different γ was applied in the Perturb-DFT initialization scheme, and an ADCNet was trained (without pretraining) on the labeled RADIal dataset using the supervised multi-task learning setup in Section 1.2. Table 6 shows the results: large γ (e.g. γ=2) brought significant degradation to both object detection and freespace segmentation, while a small γ like 0.1 achieved better performance than if no perturbation (γ=0) was applied.

TABLE 6
The effect of the γ parameter in Perturb-DFT initialization

| γ | AP(%) | AR(%) | RE(m) | AE (°) | mIOU |
|---|---|---|---|---|---|
| 0 | 96.0 | 84,0 | 0.13 | 0.10 | 70.39% |
| 0.1 | 95.7 | 86.8 | 0.12 | 0.10 | 74.45% |
| 0.5 | 88.4 | 81,0 | 0.16 | 0.13 | 70.03% |
| 2 | 75.4 | 57.1 | 0.18 | 0.12 | 69.47% |

### 3. Summary

In general, an E2E machine learning system can be used to generate RD and RAD data sets based on raw radar ADC data. To overcome the difficulty associated with learning from the ADC data, a learnable DSP module, as well as an effective pre-training strategy can be employed. The combination of these techniques resulted in improved object detection and freespace segmentation results on the RADIal dataset.

The designed learnable DSP module described herein can be is modular, such that it can be used with other backbone and other head networks to tackle other AV perception tasks. In the same vein, the pre-training technique also can be adapted for other radar-based perception tasks.

### Example DFT Layers

By radar hardware and waveform design, applying DFT on the chirp sequence dimension (“fast time”) yields range information of targets, while applying DFT across chirps (“slow time”) dimension yields the Doppler information—which tells how fast the target is moving along the radial direction.

In the E2E machine learning systems described above, real and imaginary component of the DFT operator can be represented separately by real-valued matrices. These matrices can initialized by the actual DFT coefficients, and are left trainable. Further, the DFT can be applied to the fast time dimension first, and applied to the slow time dimension second in order to fully recover the signal processing chain used in RADIal dataset.

### Example Hanning Window Layers

The Hanning window is a technique to modulate input signal, before applying DFT on it. A window function is applied, since fundamentally, DFT assumes that the input digital samples are an integer number of periods of a periodic signal. This is violated when the first and last entry of the input signal are not equal, creating discontinuous functions. Applying DFT directly on these signal results in frequency leakage (e,g, “smearing”).

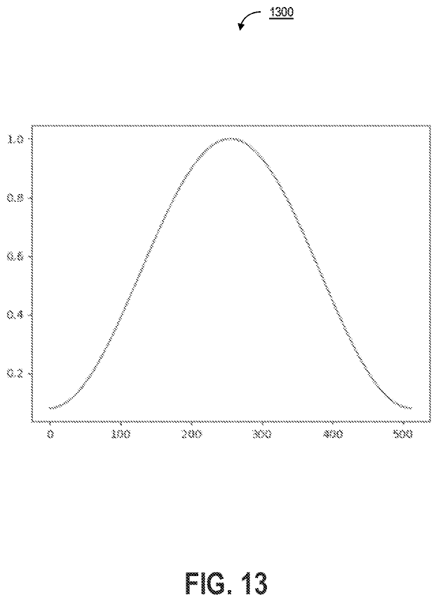

An example of a 512-point Hanning window 1300 is show in FIG. 13. This 1-D function is multiplied to the appropriate axis (range or doppler dimension) in the neutral network module above. The coefficients are initialized with Hanning window coefficients, and is trainable in the neural network.

### Example Changes to the DFT Laver and Hanning Window Layers After Training

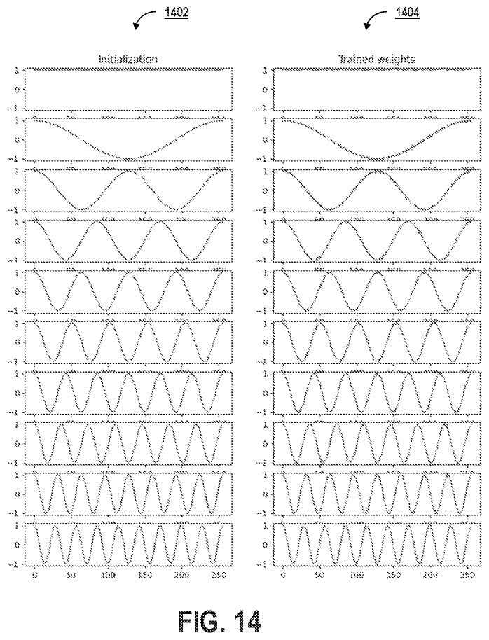

FIG. 14 compares the real part of the Doppler DFT weights (dim=256), before and after training (plots 1402 and 1404, respectively). To save space, only the first 10 rows of the DFT matrix are visualized. As shown in FIG. 14, for this E2E training, changes on the DFT part are small. Similar observations are seen for the imaginary part of this DFT matrix, as well as those for the Range DFT.

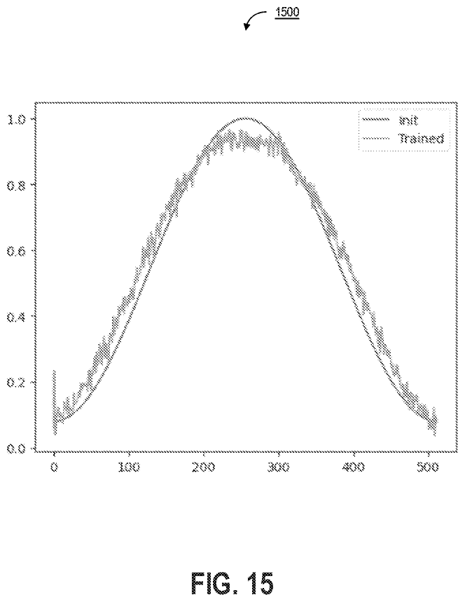

FIG. 15 shows the Hanning window 1500 for the range dimension, before and after training.

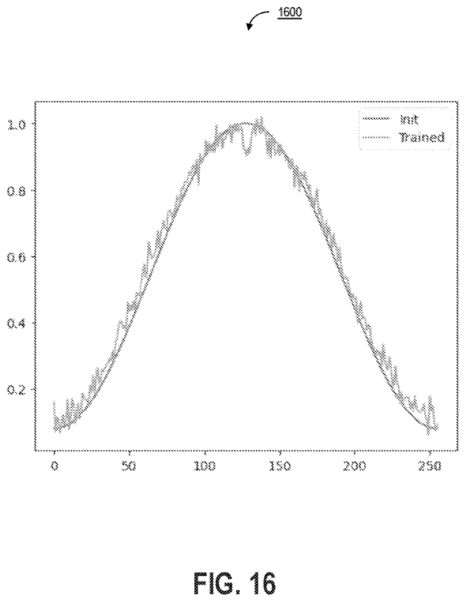

FIG. 16 shows the Hanning window 1600 for the Doppler dimension, before and after training.

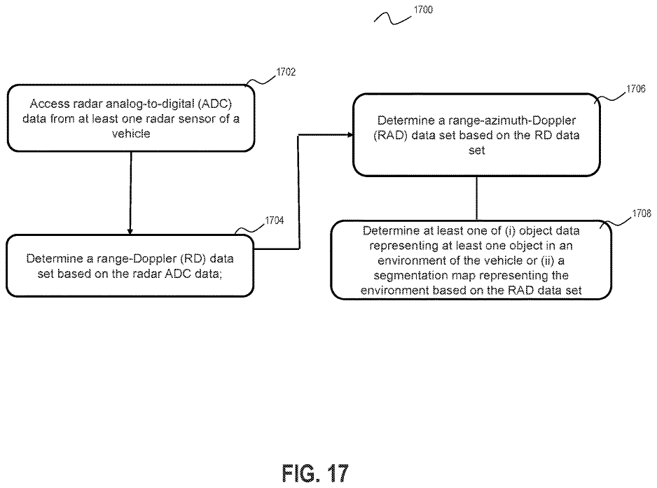

Referring now to FIG. 17, illustrated is a flowchart of a process 1700 for processing radar data. In some embodiments, one or more of the steps described with respect to process 1700 are performed (e.g., completely, partially, and/or the like) by one or more components of an autonomous vehicle, such as one or more processors that implement the autonomous vehicle compute 400 shown in FIG. 4. Additionally, or alternatively, in some embodiments one or more steps described with respect to process 1700 are performed (e.g., completely, partially, and/or the like) by another device or group of devices separate from an autonomous vehicle, such as by one or more processors of a remote computer system (e.g., a remote AV system 114, fleet management system 116, V2I system 118, etc.).

According to the process 1700, one or more processors access radar analog-to-digital (ADC) data from at least one radar sensor of a vehicle (1702).

In some implementations, accessing the radar ADC data can include accessing the radar ADC data from one or more Frequency Modulated Continuous Wave (FMCW) radar sensors.

In some implementations, the vehicle can be a ground transportation vehicle.

In some implementations, the radar ADC data set can be generated by digitizing at least one analog signal output by the at least one radar sensor.

In some implementations, the radar ADC data can include at least one real number component and at least one imaginary number component.

Further, the one or more processors determine a range-Doppler (RD) data set based on the radar ADC data (1704).

In some implementations, the RD data set can be determined by providing the radar ADC data set to a first machine learning circuit as an input, and obtaining the RD data set from the first machine learning circuit as an output based on providing the radar ADC data set to the first machine learning model.

In some implementations, determining the RD data set can include processing the radar ADC data using at least one window function layer of the first machine learning circuit, and processing the radar ADC data using at least one digital Fourier transform (DFT) layer of the first machine learning circuit.

In some implementations, determining the RD data set can include applying a first window function to a first dimension of the ADC data using a first window function layer of the first machine learning circuit.

In some implementations, applying the first window function to the first dimension of the ADC data can include applying a Hanning window function to the first dimension of the ADC data.

In some implementations, determining the RD data set can include performing a first DFT with respect to the first dimension of the ADC data using a first DFT layer of the first machine learning circuit.

In some implementations, determining the RD data set can include applying a second window function to a second dimension of the ADC data using the second DFT layer of the first machine learning circuit.

In some implementations, applying the second window function to the second dimension of the ADC data can include applying a Hanning window function to the second dimension of the ADC data.

In some implementations, determining the RD data set can include performing a second DFT with respect to the second dimension of the ADC data using a second DFT layer of the first machine learning circuit.

Further, the one or more processors determine a range-azimuth-Doppler (RAD) data set based on the RD data set (1706).

Further, the one or more processors determine at least one of (i) object data representing at least one object in an environment of the vehicle or (ii) a segmentation map representing the environment based on the RAD data set (1708).

In some implementations, determining the segmentation map can include determining one or more first regions representing a drivable space of the environment, and one or more second regions presenting a non-drivable space of the environment.

In some implementations, the process 1700 can also include selecting a frequency response of the at least one window function layer based on a training data set that includes (i) additional ADC data obtained from at least one additional radar sensor, and (ii) additional RAD data corresponding the additional ADC data.

In some implementations, the process 1700 can also include selecting a frequency response of the at least one DFT layer based on a training data set that includes (i) additional ADC data obtained from at least one additional radar sensor, and (ii) additional RAD data corresponding the additional ADC data.

In some implementations, the process 1700 can also include training the machine learning circuit based on a training data set that includes (i) additional ADC data obtained from at least one additional radar sensor of at least one additional vehicle, and (ii) at least one of: additional object data representing at least one additional object in an environment of the at least one additional vehicle, or at least one additional segmentation map representing the environment of the at least one additional vehicle.

In some implementations, training the machine learning circuit can include training the machine learning circuit based on the object data comprising at least one of: an indication of a distance of the at least one object from to the vehicle, an indication of a heading of the at least one object relative to the vehicle, or an indication of a velocity of the at least one object.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
accessing, using at least one processor, radar analog-to-digital (ADC) data from at least one radar sensor of a vehicle;
determining, using the at least one processor, a range-Doppler (RD) data set based on the radar ADC data;
determining, using the at least one processor, a range-azimuth-Doppler (RAD) data set based on the RD data set; and
determining, using the at least one processor, at least one of (i) object data representing at least one object in an environment of the vehicle or (ii) a segmentation map representing the environment based on the RAD data set.

2. The method of claim 1, wherein accessing the ADC data comprises:
accessing the ADC data, wherein the radar ADC data set is generated by digitizing at least one analog signal output by the at least one radar sensor.

3. The method of claim 1, wherein accessing the ADC data comprises:
accessing the ADC data, wherein the radar ADC data comprises at least one real number component and at least one imaginary number component.

4. The method of claim 1, wherein determining the RD data set comprises:
providing the radar ADC data set to a first machine learning circuit as an input, and
obtaining the RD data set from the first machine learning circuit as an output based on providing the radar ADC data set to the first machine learning model.

5. The method of claim 1, wherein determining the RD data set comprises:
processing the radar ADC data using at least one window function layer of the first machine learning circuit, and
processing the radar ADC data using at least one digital Fourier transform (DFT) layer of the first machine learning circuit.

6. The method of claim 5, wherein determining the RD data set comprises:
applying a first window function to a first dimension of the ADC data using a first window function layer of the first machine learning circuit.

7. The method of claim 6, wherein applying the first window function to the first dimension of the ADC data comprises applying a Hanning window function to the first dimension of the ADC data.

8. The method of claim 6, wherein determining the RD data set comprises:
performing a first DFT with respect to the first dimension of the ADC data using a first DFT layer of the first machine learning circuit.

9. The method of claim 6, wherein determining the RD data set comprises:
applying a second window function to a second dimension of the ADC data using the second DFT layer of the first machine learning circuit.

10. The method of claim 9, wherein applying the second window function to the second dimension of the ADC data comprises applying a Hanning window function to the second dimension of the ADC data.

11. The method of claim 9, wherein determining the RD data set comprises:
performing a second DFT with respect to the second dimension of the ADC data using a second DFT layer of the first machine learning circuit.

12. The method of claim 1, further comprising selecting a frequency response of the at least one window function layer based on a training data set comprising:
additional ADC data obtained from at least one additional radar sensor, and
additional RAD data corresponding the additional ADC data.

13. The method of claim 1, further comprising selecting a frequency response of the at least one DFT layer based on a training data set comprising:
additional ADC data obtained from at least one additional radar sensor, and
additional RAD data corresponding the additional ADC data.

14. The method of claim 1, further comprising training the machine learning circuit based on a training data set comprising:
additional ADC data obtained from at least one additional radar sensor of at least one additional vehicle, and
at least one of:
additional object data representing at least one additional object in an environment of the at least one additional vehicle, or
at least one additional segmentation map representing the environment of the at least one additional vehicle.

15. The method of claim 1, wherein training the machine learning circuit comprises training the machine learning circuit based on the object data comprising at least one of:
an indication of a distance of the at least one object from to the vehicle,
an indication of a heading of the at least one object relative to the vehicle, or
an indication of a velocity of the at least one object.

16. The method of claim 1, wherein determining the segmentation map comprises determining:
one or more first regions representing a drivable space of the environment, and
one or more second regions presenting a non-drivable space of the environment.

17. The method of claim 1, wherein accessing the radar ADC data comprises accessing the radar ADC data from one or more Frequency Modulated Continuous Wave (FMCW) radar sensors.

18. The method of claim 1, wherein the vehicle is a ground transportation vehicle.

19. A system comprising:
at least one processor; and
at least one non-transitory storage media storing instructions that, when executed by the at least one processor, cause the at least one processor perform operations comprising:
accessing radar analog-to-digital (ADC) data from at least one radar sensor of a vehicle;
determining a range-Doppler (RD) data set based on the radar ADC data;
determining a range-azimuth-Doppler (RAD) data set based on the RD data set; and
determining at least one of (i) object data representing at least one object in an environment of the vehicle or (ii) a segmentation map representing the environment based on the RAD data set.

20. At least one non-transitory storage media storing instructions that, when executed by at least one processor, cause the at least one processor perform operations comprising:
accessing radar analog-to-digital (ADC) data from at least one radar sensor of a vehicle;
determining a range-Doppler (RD) data set based on the radar ADC data;
determining a range-azimuth-Doppler (RAD) data set based on the RD data set; and
determining at least one of (i) object data representing at least one object in an environment of the vehicle or (ii) a segmentation map representing the environment based on the RAD data set.
